(19) United States
(12) Patent Application Publication
(10) Pub. No.: US 2021/0133442 A1
(43) Pub. Date: May 6, 2021

(54) ELEMENT OPERATION DIVISION DEVICE, ELEMENT OPERATION DIVISION METHOD, STORAGE MEDIUM, AND ELEMENT OPERATION DIVISION SYSTEM

(71) Applicant: OMRON Corporation, Kyoto (JP)

(72) Inventors: Danni Wang, Kyoto-shi (JP); Yuji Mizuno, Nara-shi (JP); Yuichiro Higashi, Kizugawa-shi (JP); Hirotaka Wada, Kyoto-shi (JP)

(73) Assignee: OMRON Corporation, Kyoto (JP)

(21) Appl. No.: 17/068,822

(22) Filed: Oct. 12, 2020

(30) Foreign Application Priority Data
Nov. 5, 2019 (JP) 2019-200826

(51) Int. Cl. G06K 9/00; G01B 11/00; G06T 7/70; G01B 7/004; H04N 5/247

(52) U.S. Cl. CPC G06K 9/00624; G01B 11/002; G06T 7/70; G06T 2207/30196; G01B 7/004; G06T 2207/30108; H04N 5/247; G06K 9/00382

(57) ABSTRACT

An element operation division device includes: acquisition unit that acquires time-series information relating to action of operator; detection unit that detects, from the time-series information, target action determined in advance in order that the target action is judged to correspond to action of contacting or separating parts; generation unit that associates action information indicating the detected target action with occurrence time of the target action and identification information of the parts to generate target action information; storage unit that stores element operation information generated by associating start action information of starting each element operation and end action information of ending each element operation with each element operation; and output unit that outputs, based on the target action information and the element operation information, data in which start time and end time of each element operation are associated with this element operation for each piece of identification information of the parts.

### CROSS-REFERENCE TO RELATED APPLICATION

This application claims the priority benefit of Japan application serial no. 2019-200826, filed on Nov. 5, 2019. The entirety of the above-mentioned patent application is hereby incorporated by reference herein and made a part of this specification.

### BACKGROUND

### Technical Field

The disclosure relates to an element operation division device, an element operation division method, a storage medium, and an element operation division system.

### Related Art

At a production site such as a factory, the skill or the like of an operator may be evaluated by analyzing an action of the operator. For example, patent literature 1 described below discloses a route scheduling device that detects an action relating to picking of the operator by a picking detection mechanism and evaluates an operation proficiency level of the operator. The route scheduling device detects an action of picking a part for each part type, and schedules a route by using an operation time calculated based on data from the picking action of one part to the picking action of a subsequent part as the operation proficiency level.

In addition, patent literature 2 described below discloses a workability evaluation device which analyzes operation data indicating an action of the operator recorded by a sensor attached to the operator and evaluates the workability of the operator. The workability evaluation device divides the operation into a plurality of partial operations based on a change in the action of the operator, and evaluates the workability for each partial operation.

### LITERATURE OF RELATED ART

### Patent Literature

[Patent literature 1] Japanese Patent Laid-open No. 8-174387
[Patent literature 2] Japanese Patent Laid-open No. 2018-45512

### SUMMARY

### Problems to be Solved

In patent literature 1, although the picking action of the operator can be detected, other actions cannot be detected, and thus the operation from picking of one part to picking of a subsequent part cannot be further divided into partial operations and evaluated. In addition, in patent literature 2, because the operation is divided into partial operations based on a change in the action of the operator, the operation in which a change in the movement is almost the same regardless of the operator can be divided into partial operations on the basis of giving a predetermined meaning to the action of each operator. However, in the operation in which a change in the movement is different for each operator, there is a possibility that uniform skill evaluation cannot be performed because granularity of operation partition or the meaning of action may change depending on the operator.

Therefore, the disclosure provides an element operation division device, an element operation division method, a storage medium, and an element operation division system capable of dividing an operation state of an operator in units that are easy to grasp objectively.

### Means to Solve Problems

An element operation division device according to one aspect of the disclosure includes: an acquisition unit that acquires time-series information relating to an action of an operator; a detection unit that detects, from the time-series information, a target action which is determined in advance in order that the target action is judged to correspond to an action of contacting or separating parts; a generation unit that associates action information indicating the detected target action with an occurrence time of the target action and identification information of the parts to generate target action information; a storage unit that stores element operation information generated by associating start action information and end action information with respective element operations, wherein the start action information indicates an action of starting each of a plurality of the element operations in a series of operations, and the end action information indicates an action of ending each of the element operations; and an output unit that outputs, based on the target action information and the element operation information, data in which a start time and an end time of each of the element operations are associated with this element operation for each piece of identification information of the parts.

According to this aspect, the time-series information relating to the action of the operator can be acquired, the target action of contacting or separating the parts can be detected from the time-series information, the target action information in which the detected target action is associated with the occurrence time thereof and the identification information of the parts can be generated, and the data for dividing the time-series information in part units and element operation units can be output based on the target action information and the element operation information in which a start action and an end action of each element operation are determined.

In the above aspect, the time-series information may be time-series information output by at least one of an image sensor, a pressure sensor, a photoelectric sensor, and a line-of-sight detection sensor.

According to this aspect, the data for dividing the time-series information output by any one of the image sensor, the pressure sensor, the photoelectric sensor, and the line-of-sight detection sensor can be divided in the part units and the element operation units.

In the above aspect, when the time-series information is output by the image sensor, the detection unit may detect the target action based on a position on an image at which a hand of the operator is present.

According to this aspect, from the time-series information output by the image sensor, the target action can be detected based on the position on the image at which the hand of the operator is present.

In the above aspect, when the time-series information is detected by the pressure sensor, the detection unit may detect the target action based on a position on an operation table corresponding to a pressure sensor in which a pressure value has changed among a plurality of pressure sensors arranged on the operation table and a change state of the pressure value.

According to this aspect, from the time-series information output by the pressure sensor, the target action can be detected based on the position on the operation table corresponding to the pressure sensor in which the pressure value has changed and the change state of the pressure value.

In the above aspect, when the time-series information is detected by the photoelectric sensor, the detection unit may detect the target action based on a position on an operation table corresponding to a photoelectric sensor in which an output signal has changed among a plurality of photoelectric sensors arranged on the operation table.

According to this aspect, from the time-series information output by the photoelectric sensor, the target action can be detected based on the position on the operation table corresponding to the photoelectric sensor in which the output signal has changed.

An element operation division method according to another aspect of the disclosure includes: acquiring time-series information relating to an action of an operator; detecting, from the time-series information, a target action which is determined in advance in order that the target action is judged to correspond to an action of contacting or separating parts; associating action information indicating the detected target action with an occurrence time of the target action and identification information of the parts to generate target action information; storing element operation information generated by associating start action information and end action information with respective element operations, wherein the start action information indicates an action of starting each of a plurality of the element operations in a series of operations, and the end action information indicates an action of ending each of the element operations; and outputting, based on the target action information and the element operation information, data in which a start time and an end time of each of the element operations are associated with this element operation for each piece of identification information of the parts.

According to this aspect, the time-series information relating to the action of the operator can be acquired, the target action of contacting or separating the parts can be detected from the time-series information, the target action information in which the detected target action is associated with the occurrence time thereof and the identification information of the parts can be generated, and the data for dividing the time-series information in part units and element operation units can be output based on the target action information and the element operation information in which a start action and an end action of each element operation are determined.

A non-transitory computer readable storage medium, storing an element operation division program according to another aspect of the disclosure causes a computer to function as: an acquisition unit that acquires time-series information relating to an action of an operator; a detection unit that detects, from the time-series information, a target action which is determined in advance in order that the target action is judged to correspond to an action of contacting or separating parts; a generation unit that associates action information indicating the detected target action with an occurrence time of the target action and identification information of the parts to generate target action information; a storage unit that stores element operation information generated by associating start action information and end action information with respective element operations, wherein the indicating an action of starting each of a plurality of the element operations in a series of operations, and the end action information indicates an action of ending each of the element operations; and an output unit that outputs, based on the target action information and the element operation information, data in which a start time and an end time of each of the element operations are associated with this element operation for each piece of identification information of the parts.

According to this aspect, the time-series information relating to the action of the operator can be acquired, the target action of contacting or separating the parts can be detected from the time-series information, the target action information in which the detected target action is associated with the occurrence time thereof and the identification information of the parts can be generated, and the data for dividing the time-series information in part units and element operation units can be output based on the target action information and the element operation information in which a start action and an end action of each element operation are determined.

An element operation division system according to another aspect of the disclosure includes one or more sensors and an element operation division device, wherein

the sensor includes an estimation unit that estimates an action of an operator and outputs time-series information relating to the action, and

the element operation division device includes: an acquisition unit that acquires the time-series information; a detection unit that detects, from the time-series information, a target action which is determined in advance in order that the target action is judged to correspond to an action of contacting or separating parts; a generation unit that associates action information indicating the detected target action with an occurrence time of the target action and identification information of the parts to generate target action information; a storage unit that stores element operation information generated by associating start action information and end action information with respective element operations, wherein the start action information indicates an action of starting each of a plurality of the element operations in a series of operations, and the end action information indicates an action of ending each of the element operations; and an output unit that outputs, based on the target action information and the element operation information, data in which a start time and an end time of each of the element operations are associated with this element operation for each piece of identification information of the parts.

According to this aspect, the time-series information relating to the action of the operator can be acquired, the target action of contacting or separating the parts can be detected from the time-series information, the target action information in which the detected target action is associated with the occurrence time thereof and the identification information of the parts can be generated, and the data for dividing the time-series information in part units and element operation units can be output based on the target action information and the element operation information in which a start action and an end action of each element operation are determined.

### Effect

According to the disclosure, it is possible to provide an element operation division device, an element operation division method, a storage medium, and an element operation division system capable of dividing an operation state of an operator in units that are easy to grasp objectively.

### BRIEF DESCRIPTION OF THE DRAWINGS

FIG. 1 is a diagram illustrating an overview of an element operation division system according to an embodiment of the disclosure.

FIG. 2 is a schematic diagram illustrating that parts accommodated in each part box are assembled to create a finished product.

FIG. 3 is a diagram illustrating functional configurations of an element operation division system according to the embodiment.

FIG. 4 is a diagram showing an example of target action information stored in an element operation division device according to the embodiment.

FIG. 5 is a diagram showing an example of element operation information stored in the element operation division device according to the embodiment.

FIG. 6 is a diagram showing an example of part unit element operation data stored in the element operation division device according to the embodiment.

FIG. 7 is a diagram illustrating hardware configurations of the element operation division device according to the embodiment.

FIG. 8 is a flowchart of an element operation division process executed by the element operation division device according to the embodiment.

FIG. 9 is a diagram illustrating an overview of an element operation division system according to a first variation example.

FIG. 10 is a flowchart of an element operation division process executed by an element operation division device according to the first variation example.

FIG. 11 is a diagram illustrating an overview of an element operation division system according to a second variation example.

FIG. 12 is a flowchart of an element operation division process executed by an element operation division device according to the second variation example.

### DESCRIPTION OF THE EMBODIMENTS

Hereinafter, an embodiment according to one aspect of the disclosure (hereinafter referred to as “the embodiment”) is described with reference to the drawings. Moreover, in each of the drawings, those denoted by the same reference numerals have the same or similar configurations.

### § 1 Application Example

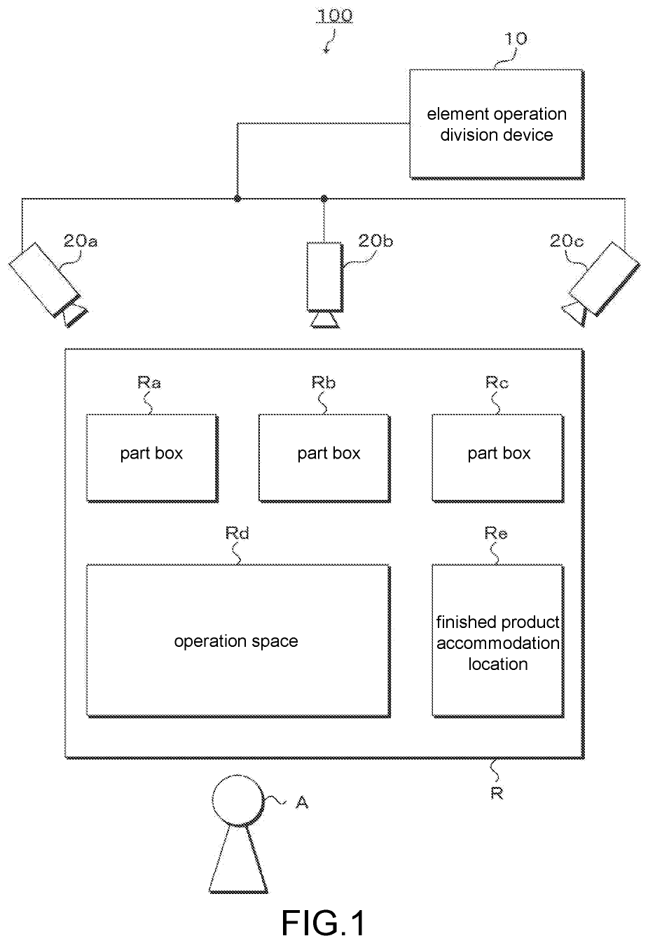

First, an example of a scene in which the disclosure is applied is described with reference to FIG. 1. An element operation division system 100 according to the embodiment captures an image of an action (operation state) of an operator A performed in one operation region (operation table) R with image sensors 20a, 20b, and 20c, and an element operation division device 10 that has acquired the captured moving image divides, based on a target action of contacting or separating parts and element operations included in a series of operations, the action of the operator A included in the moving image into element operations in part units.

The target action of contacting or separating parts may be, for example, each action of a hand contacting a part, a part being separated from a part, a part contacting a part, a finished product contacting an accommodation location, a hand being separated from a finished product, and the like.

The element operation included in a series of operations may be, for example, an operation of “gripping” each of the parts accommodated in each of part boxes Ra, Rb, and Rc, an operation of “transporting” the gripped parts to an operation space Rd, an operation of “adjusting” a part obtained by assembling the parts transported to the operation space Rd, an operation of “accommodating” the finished product in an accommodation location Re, and the like.

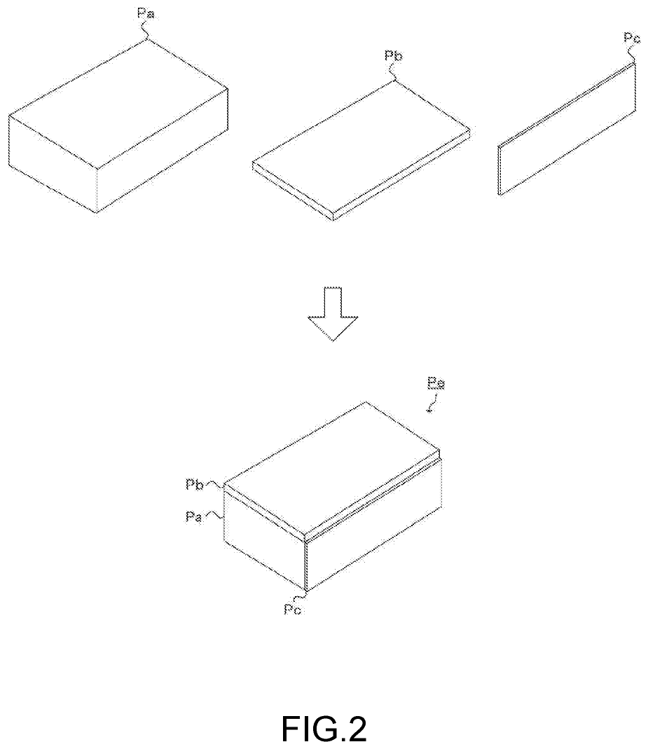

Here, an example of the operation performed by the operator A in an operation region R is described with reference to FIGS. 1 and 2. The operator A sequentially grips one part Pa, one part Pb, and one part Pc from a group of parts Pa, a group of parts Pb, and a group of parts Pc accommodated in the part box Ra, the part box Rb, and the part box Re (the element operation: gripping), and respectively transports the part Pa, the part Pb, and the part Pc onto the operation space Rd (the element operation: transportation). Subsequently, the operator A sequentially assembles the part Pa, the part Pb, and the part Pc on the operation space Rd (the element operation: adjustment), and accommodates an assembled finished product Pe in the accommodation location Re (element operation: accommodation).

An image of the action of the operator A who performs this operation is captured by the image sensors 20a, 20b, and 20c, and the captured moving image is acquired by the element operation division device 10. The element operation division device 10 detects a target action from the acquired moving image, and generates target action information including the occurrence time of the detected target action and identification information of the parts. Subsequently, based on the target action information and element operation information in which a start action and an end action of the element operation are determined for each element operation, the element operation division device 10 generates and outputs data in which the start time and the end time of each element operation are associated with each part.

In this way, according to the element operation division device 10 of the embodiment, it is possible to divide an action (operation state) of an operator in units such as part units and element operation units that are easy to grasp objectively.

### § 2 Configuration Example

### [Functional Configuration]

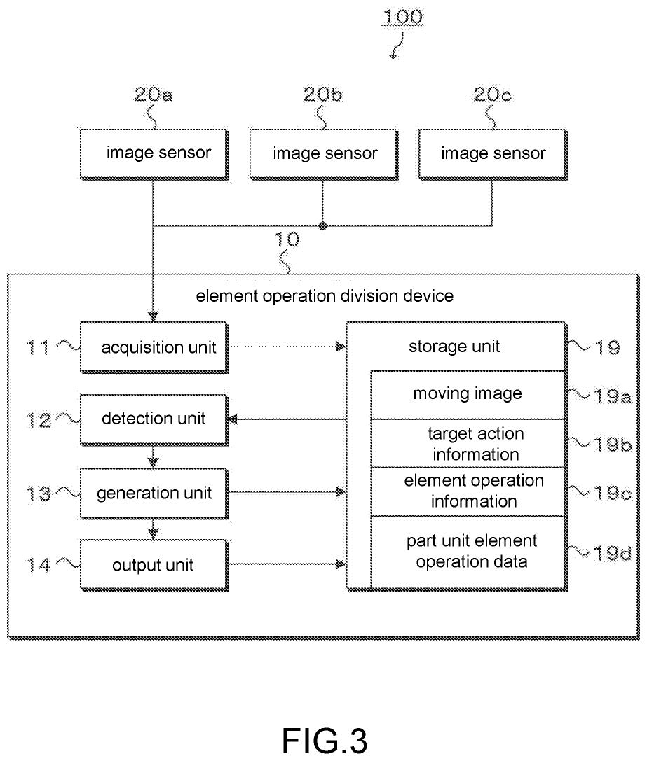

Next, an example of functional configurations of the element operation division system 100 according to the embodiment is described with reference to FIG. 3. The element operation division system 100 includes three image sensors 20a, 20b, and 20c and the element operation division device 10. In the following, the three image sensors 20a, 20b, and 20c are referred to as image sensors 20 unless it is necessary to distinguish the three image sensors. The element operation division device 10 has, for example, an acquisition unit 11, a detection unit 12, a generation unit 13, an output unit 14, and a storage unit 19 as functional configurations. The storage unit 19 stores, for example, a moving image 19a, target action information 19b, element operation information 19c, and part unit element operation data 19d. Details of each functional configuration are described below in order.

<Image Sensor>

The image sensor 20 is, for example, a general-purpose camera, and captures a moving image including a scene in which the operator A is acting in the operation region R. The image sensor 20 has, for example, an estimation unit as a functional configuration. The estimation unit estimates an action of the operator A and outputs a moving image indicating the action as time-series information.

The image sensors 20a, 20b, and 20c are arranged in order that images of the entire operation region R and the operator A can be captured. For example, each of the image sensors 20a, 20b, and 20c may be arranged in order that images of the entire operation region R and the operator A can be captured, or each of the image sensors 20a, 20b, and 20c may be arranged in order that images of a part of the operation region R and the operator A are captured and the entire operation region R and the operator A can be covered by combining the respective moving images. In addition, each of the image sensors 20a, 20b, and 20c may capture images of the operation region R and the operator A at different magnifications. It is not necessary to include three image sensors 20, but at least one image sensor may be included.

<Acquisition Unit>

The acquisition unit 11 acquires, from the image sensor 20, the time-series information (a moving image in the embodiment) relating to the action performed by the operator A. The time-series information acquired by the acquisition unit 11 is transmitted to the storage unit 19 and stored as the moving image 19a.

<Detection Unit>

The detection unit 12 recognizes a position on the image at which a hand of the operator A is present from the moving image 19a and detects a target action. The target action is determined in advance in order that the action recognized from the moving image 19a can be judged to correspond to the action of contacting or separating the parts. As the target action, for example, each action of a hand contacting a part, a part being separated from a part, a part contacting a part, a finished product contacting an accommodation location, a hand being separated from a finished product, and the like can be set. The target action can be appropriately set according to the operation content, and it is preferable that the content of the set target action is stored in the storage unit 19 as action information.

For example, the detection unit 12 recognizes a position on the image of the moving image 19a at which a hand of the operator A is present, and when an action is judged to correspond to the action of the hand of the operator A contacting a part, the detection unit 12 detects this action as the target action.

<Generation Unit>

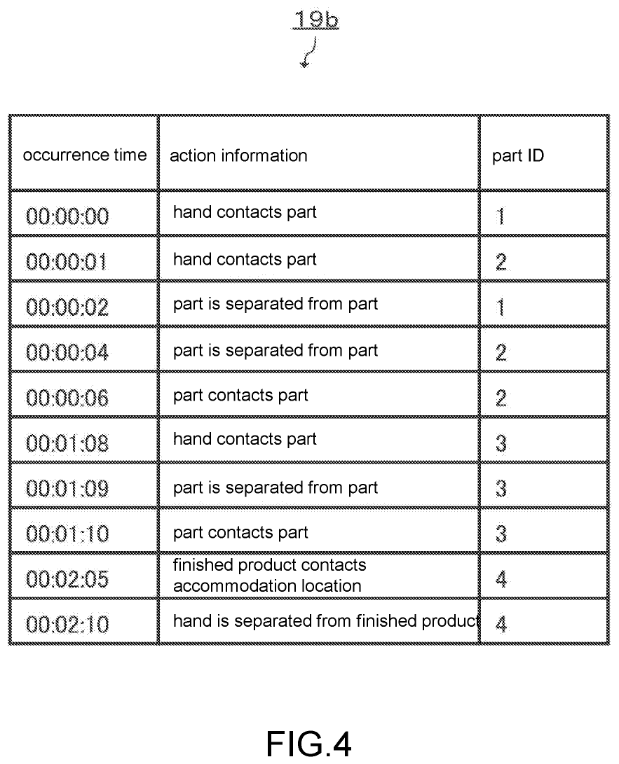

The generation unit 13 associates the action information indicating the target action detected by the detection unit 12 with the occurrence time of the target action and a part ID (identification information of the parts) to generate the target action information 19b. The target action information 19b is described with reference to FIG. 4.

The target action information 19b has, for example, an occurrence time item, an action information item, and a part ID item as data items. The occurrence time item stores a time when the target action occurs. As the occurrence time, for example, an elapsed time from the time when the series of operation is started can be used. The action information item stores the content of the above-described target action. The part ID item stores identification information for specifying the parts. For example, the part ID of the part Pa shown in FIG. 2 can be set as “1”, the part ID of the part Pb can be set as “2”, the part ID of the part Pc can be set as “3”, and the part ID of the finished product Pe can be set as “4”.

The target action information 19b illustrated in FIG. 4 is generated by the following actions (1) to (10). (1) The hand contacts the part Pa at “00:00:00”. (2) The hand contacts the part Pb at “00:00:01”. (3) The part Pa is separated from the group of parts Pa in the part box Ra at “00:00:02”. (4) The part Pb is separated from the group of parts Pb in the part box Rb at “00:00:04”. (5) The part Pb contacts the part Pa at “00:00:06”. (6) The hand contacts the part Pc at “00:01:08”. (7) The part Pc is separated from the group of parts Pc in the part box Re at “00:01:09”. (8) The part Pc contacts the parts (part Pa+part Pb) at “00:01:10”. (9) The finished product Pe contacts the accommodation location Re at “00:02:05”. (10) The hand is separated from the finished product Pe at “00:02:10”.

<Output Unit>

Return to the description of FIG. 3. The output unit 14 outputs the part unit element operation data 19d based on the target action information 19b and the element operation information 19c. The output part unit element operation data 19d is stored in the storage unit 19. The element operation information 19c and the part unit element operation data 19d are described below in order.

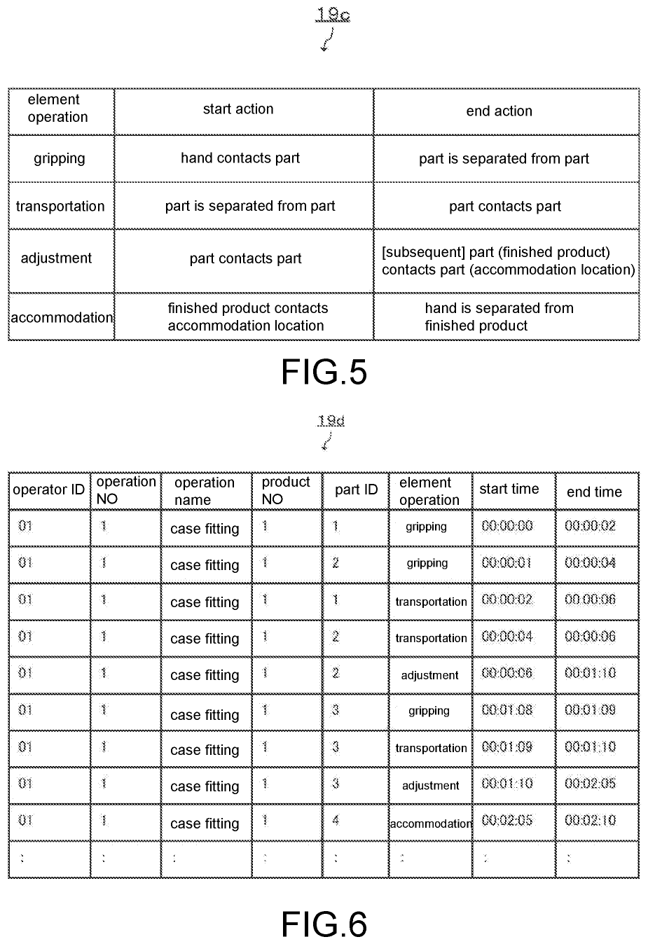

The element operation information 19c is described with reference to FIG. 5. The element operation information 19c has, for example, an element operation item, a start action item, and an end action item as data items. The element operation item stores any one of the element operations included in the series of operations. The start action item stores an action of starting the element operation. The end action item stores an action of ending the element operation.

Illustratively, when the element operation is “gripping”, the action of “a hand contacting a part” becomes the start action, and the action of “a part being separated from a part” becomes the end action. When the element operation is “transportation”, the action of “a part being separated from a part” becomes the start action, and the action of “a part contacting a part” becomes the end action. When the element operation is “adjustment”, the action of “a part contacting a part” becomes the start action, and the action of “a (subsequent) part contacting a part” becomes the end action. When the element operation is “accommodation”, the action of “a finished product contacting an accommodation location” becomes the start action, and the action of “a hand being separated from a finished product” becomes the end action.

The part unit element operation data 19d is described with reference to FIG. 6. The part unit element operation data 19d is data in which the start time and the end time of each element operation are associated with this element operation for each part ID. The part unit element operation data 19d has, for example, an operator ID item, an operation NO item, an operation name item, a product NO item, a part ID item, an element operation item, a start time item, and an end time item as data items.

The operator ID item stores identification information of specifying the operator A. The operation NO item stores identification information for specifying the operation. The operation name item stores a name of the operation. The product NO item stores identification information of specifying the product. The part ID item stores identification information for specifying the parts. The element operation item stores any one of the element operation included in the series of operation. The start time item stores the time when the element operation is started. The end time item stores the time when the element operation is ended. As the start time and the end time, for example, an elapsed time from the time when the series of operation is started can be used.

The part unit element operation data 19d shown in FIG. 6 illustrates that each element operation of “gripping” and “transportation” is performed on the part Pa of which the part ID is “1”, each element operation of “gripping”, “transportation”, and “adjustment” is performed on the part Pb of which the part ID is “2”, each element operation of “gripping”, “transportation”, and “adjustment” is performed on the part Pc of which the part ID is “3”, and each element operation of “gripping”, “transportation”, and “adjustment” is performed on the finished product Pe of which the part ID is “4”.

The nine pieces of part unit element operation data 19d illustrated in FIG. 6 are generated as follows based on the target action information 19b illustrated in FIG. 4 and the element operation information 19c illustrated in FIG. 5.

(First piece of data) The data shown in FIG. 6 in which the part ID is “1” and the element operation is “gripping” is generated by judging that the action of “a hand contacting a part” shown in FIG. 4 when the occurrence time is “00:00:00” and the part ID is “1” corresponds to the start action of “gripping” shown in FIG. 5, and further judging that the action of “a part being separated from a part” shown in FIG. 4 when the occurrence time is “00:00:02” and the part ID is “1” corresponds to the end action of “gripping” shown in FIG. 5.

(Second piece of data) The data shown in FIG. 6 in which the part ID is “2” and the element operation is “gripping” is generated by judging that the action of “a hand contacting a part” shown in FIG. 4 when the occurrence time is “00:00:01” and the part ID is “2” corresponds to the start action of “gripping” shown in FIG. 5, and further judging that the action of “a part being separated from a part” shown in FIG. 4 when the occurrence time is “00:00:04” and the part ID is “2” corresponds to the end action of “gripping” shown in FIG. 5.

(Third piece of data) The data shown in FIG. 6 in which the part ID is “1” and the element operation is “transportation” is generated by judging that the action of “a part being separated from a part” shown in FIG. 4 when the occurrence time is “00:00:02” and the part ID is “1” corresponds to the start action of “transportation” shown in FIG. 5, and further judging that the action of “a part contacting a part” shown in FIG. 4 when the occurrence time is “00:00:06” and the part ID is “2” corresponds to the end action of “transportation” shown in FIG. 5.

(Fourth piece of data) The data shown in FIG. 6 in which the part ID is “2” and the element operation is “transportation” is generated by judging that the action of “a part being separated from a part” shown in FIG. 4 when the occurrence time is “00:00:04” and the part ID is “2” corresponds to the start action of “transportation” shown in FIG. 5, and further judging that the action of “a part contacting a part” shown in FIG. 4 when the occurrence time is “00:00:06” and the part ID is “2” corresponds to the end action of “transportation” shown in FIG. 5.

(Fifth piece of data) The data shown in FIG. 6 in which the part ID is “2” and the element operation is “adjustment” is generated by judging that the action of “a part contacting a part” shown in FIG. 4 when the occurrence time is “00:00:06” and the part ID is “2” corresponds to the start action of “adjustment” shown in FIG. 5, and further judging that the action of “a part contacting a part” shown in FIG. 4 when the occurrence time is “00:01:10” and the part ID is “3” corresponds to the end action of “adjustment” shown in FIG. 5.

(Sixth piece of data) The data shown in FIG. 6 in which the part ID is “3” and the element operation is “gripping” is generated by judging that the action of “a hand contacting a part” shown in FIG. 4 when the occurrence time is “00:01:08” and the part ID is “3” corresponds to the start action of “gripping” shown in FIG. 5, and further judging that the action of “a part being separated from a part” shown in FIG. 4 when the occurrence time is “00:01:09” and the part ID is “3” corresponds to the end action of “gripping” shown in FIG. 5.

(Seventh piece of data) The data shown in FIG. 6 in which the part ID is “3” and the element operation is “transportation” is generated by judging that the action of “a part being separated from a part” shown in FIG. 4 when the occurrence time is “00:01:09” and the part ID is “3” corresponds to the start action of “transportation” shown in FIG. 5, and further judging that the action of “a part contacting a part” shown in FIG. 4 when the occurrence time is “00:01:10” and the part ID is “3” corresponds to the end action of “transportation” shown in FIG. 5.

(Eighth piece of data) The data shown in FIG. 6 in which the part ID is “3” and the element operation is “adjustment” is generated by judging that the action of “a part contacting a part” shown in FIG. 4 when the occurrence time is “00:01:10” and the part ID is “3” corresponds to the start action of “adjustment” shown in FIG. 5, and further judging that the action of “a finished product contacting an accommodation location” shown in FIG. 4 when the occurrence time is “00:02:05” and the part ID is “4” corresponds to the end action of “adjustment” shown in FIG. 5.

(Ninth piece of data) The data shown in FIG. 6 in which the part ID is “4” and the element operation is “accommodation” is generated by judging that the action of “a finished product contacting an accommodation location” shown in FIG. 4 when the occurrence time is “00:02:05” and the part ID is “4” corresponds to the start action of “accommodation” shown in FIG. 5, and further judging that the action of “a hand being separated from a finished product” shown in FIG. 4 when the occurrence time is “00:02:10” and the part ID is “4” corresponds to the end action of “accommodation” shown in FIG. 5.

[Hardware Configuration]

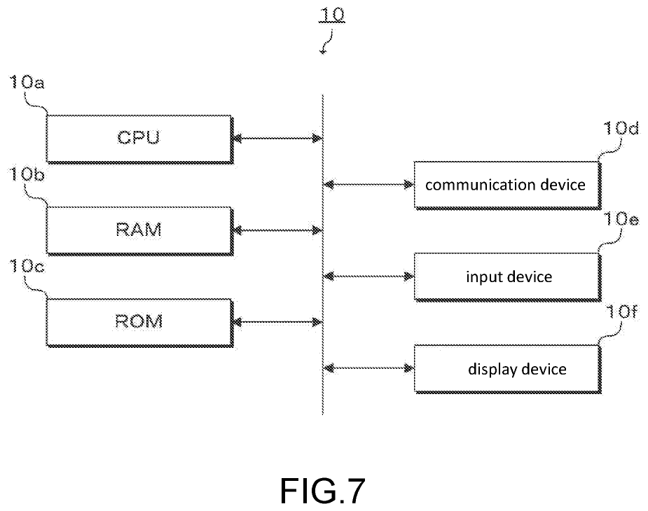

Next, an example of hardware configurations of the element operation division device 10 according to the embodiment is described with reference to FIG. 7. The element operation division device 10 includes a central processing unit (CPU) 10a corresponding to a computing device, a random access memory (RAM) 10b corresponding to the storage unit 19, a read only memory (ROM) 10c corresponding to the storage unit 19, a communication device 10d, an input device 10e, and a display device 10f. These configurations are connected via buses in order that data can be transmitted to and received from each other. Moreover, in the embodiment, a case in which the element operation division device 10 is configured by one computer is described, but the element operation division device 10 may be realized using a plurality of computers.

The CPU 10a executes a program stored in the RAM 10b or the ROM 10c, and functions as a control unit that performs calculation or processing of data. The CPU 10a receives various input data from the input device 10e and the communication device 10d, and displays a result of calculating the input data on the display device 10f or stores the result in the RAM 10b or the ROM 10c. The CPU 10a in the embodiment executes a program (an element operation division program) for dividing the action of the operator A included in the moving image 19a into element operations in part units based on the target action information 19b and the element operation information 19c.

The RAM 10b is configured by, for example, a semiconductor memory element and stores rewritable data. The ROM 10c is configured by, for example, a semiconductor memory element and stores readable and unrewritable data.

The communication device 10d is an interface that connects the element operation division device 10 to external equipment. The communication device 10d is, for example, connected to the image sensor 20 via a communication network such as a local area network (LAN) or the Internet, and receives a moving image from the image sensor 20.

The input device 10e is an interface that receives data input from a user, and can include, for example, a keyboard, a mouse, and a touch panel.

The display device 10f is an interface that visually displays a calculation result or the like obtained by the CPU 10a, and can be configured by a liquid crystal display (LCD) for example.

The element operation division program may be provided in a manner of being stored in a computer-readable storage medium such as the RAM 10b or the ROM 10c, or may be provided via a communication network connected by the communication device 10d. In the element operation division device 10, the CPU 10a executes an action recognition program, and thereby, the actions of the acquisition unit 11, the detection unit 12, the generation unit 13, and the output unit 14 shown in FIG. 3 are realized. Moreover, these physical configurations are merely examples and may not necessarily be independent configurations. For example, the element operation division device 10 may include a large-scale integration (LSI) in which the CPU 10a is integrated with the RAM 10b or the ROM 10c.

### § 3 Action Example

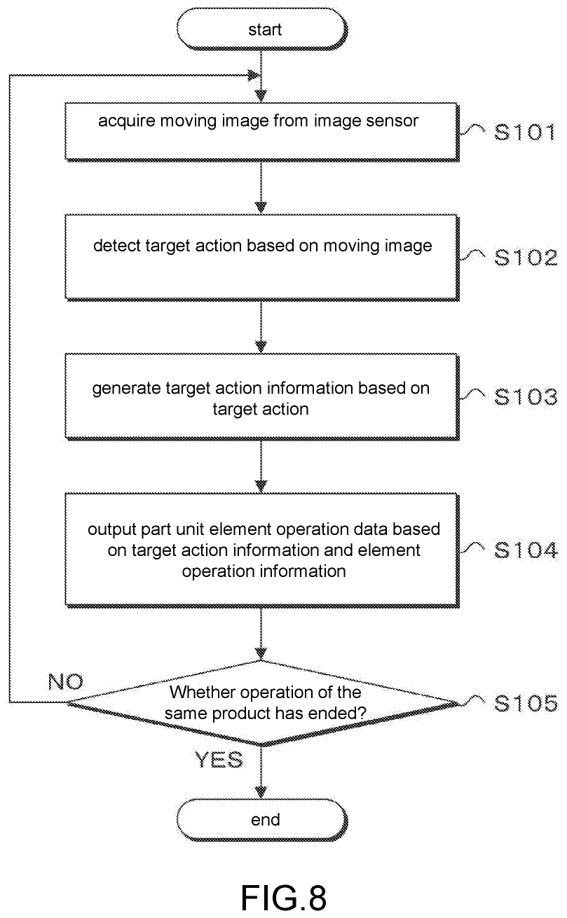

FIG. 8 is a flowchart showing an example of an element operation division process executed by the element operation division device 10 according to the embodiment.

First, the acquisition unit 11 of the element operation division device 10 acquires, from the image sensor 20, the moving image that is the time-series information relating to the action of the operator A (step S101). The acquired moving image is stored in the storage unit 19 as the moving image 19a.

Subsequently, the detection unit 12 of the element operation division device 10 recognizes, based on the moving image 19a, a position on the image at which the hand of the operator A is present, and detects a target action (step S102).

Subsequently, the generation unit 13 of the element operation division device 10 associates the action information indicating the target action detected in step S102 with the occurrence time of the target action and the part ID to generate the target action information (step S103). The generated target action information is stored in the storage unit 19 as the target action information 19b.

Subsequently, the output unit 14 of the element operation division device 10 outputs the part unit element operation data 19d based on the target action information 19b and the element operation information 19c (step S104).

Subsequently, the control unit of the element operation division device 10 judges whether the operation of the same product has ended (step S105), and when the judgment result is NO (step S105; NO), the process proceeds to step S101 described above.

When it is judged in step S105 that the operation of the same product has ended (step S105; YES), the element operation division process is ended.

As described above, according to the element operation division device 10 of the embodiment, the moving image 19a relating to the action of the operator A can be acquired, the target action of contacting or separating parts can be detected from the moving image 19a, the target action information 19b in which the detected target action is associated with the occurrence time thereof and the part ID can be generated, and the part unit element operation data 19d for dividing the moving image 19a in part units and element operation units can be output based on the target action information 19b and the element operation information 19c in which a start action and an end action of each element operation are determined.

### § 4 Variation Example

Moreover, the disclosure is not limited to the above-described embodiment, and can be implemented in various other forms without departing from the gist of the disclosure. Therefore, the above embodiment is merely an example in all respects, and is not construed as limited.

For example, in the above-described embodiment, the case in which the time-series information is a moving image has been described, but the time-series information is not limited to the moving image. Specifically, the time-series information may be information relating to coordinate values indicating the action of the operator A measured by a motion capture that is included in place of the image sensor 20, or information indicating the action of the operator A measured by mounting an acceleration sensor or a gyro sensor on the operator A in place of the image sensor 20. In addition, the time-series information may be information indicating a change state of a pressure value measured by a pressure sensor arranged in the operation region R in place of the image sensor 20, or may be information indicating a change in an event estimated by a photoelectric sensor arranged in the operation region R in place of the image sensor 20. Furthermore, the time-series information is not limited to individually using each piece of the above information, and two or more pieces of the above information may be combined.

Hereinafter, a first variation example in which the pressure sensor is arranged in place of the image sensor 20 in the embodiment, and a second variation example in which the photoelectric sensor is arranged in place of the image sensor 20 in the embodiment are described in order.

### First Variation Example

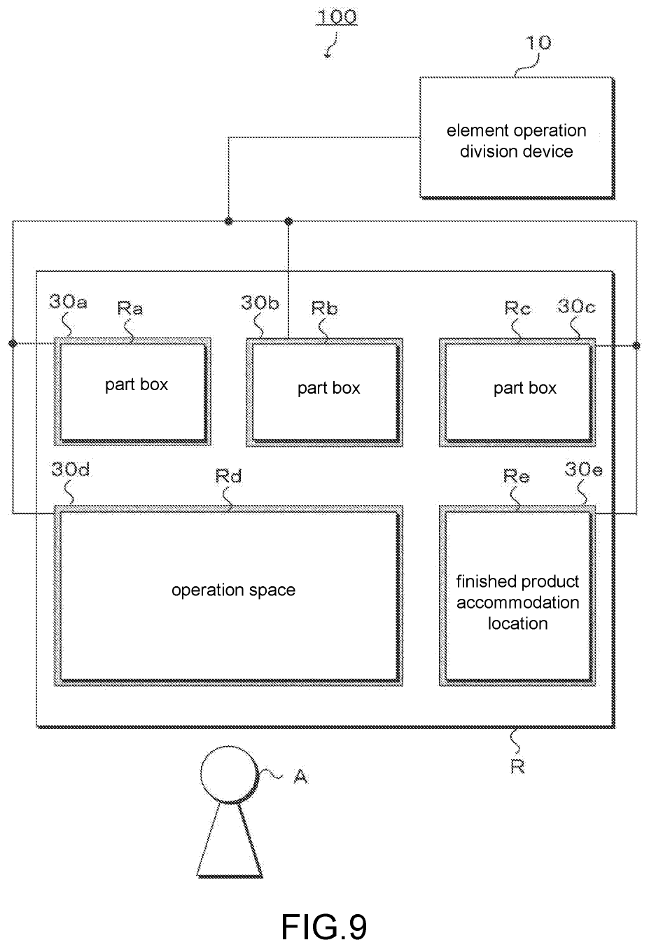

An element operation division system 100 according to the first variation example is described with reference to FIG. 9. The element operation division system 100 according to the first variation example measures a pressure that changes depending on the action (operation) of the operator A performed in one operation region (operation table) R with pressure sensors 30a, 30b, 30c, 30d, and 30e (hereinafter also referred to as “pressure sensors 30”), and transmits information indicating a change state of the measured pressure value to the element operation division device 10 as the time-series information.

The pressure sensor 30 is preferably arranged under each of the part boxes Ra, Rb, and Rc, the operation space Rd, and the finished product accommodation location Re. In addition, it is preferable that correspondence relationships of each pressure sensor 30 with each of the part boxes Ra, Rb, and Rc, the operation space Rd, and the finished product accommodation location Re are stored in the storage unit 19. Thereby, when the pressure value changes in any one of the pressure sensors 30, a position on the operation table associated with this pressure sensor 30 can be specified.

The detection unit 12 of the element operation division device 10 according to the first variation example detects the target action based on the information indicating the change state of the pressure value acquired by the acquisition unit 11. The target action can be determined in advance in order that the target action is judged to correspond to the action of contacting or separating the parts. For example, the target action is determined in advance in order that the target action is judged to correspond to each action of a hand contacting a part, a part being separated from a part, a part contacting a part, a finished product contacting an accommodation location, a hand being separated from a finished product, and the like. Specifically, when the pressure value of the pressure sensor 30a increases by a predetermined value or more, it can be judged that the hand contacts the part Pa, and when the pressure value of the pressure sensor 30a decreases by a predetermined value or more, it can be judged that the part Pa is separated from the group of parts Pa.

The generation unit 13 of the element operation division device 10 according to the first variation example generates the target action information 19b including the occurrence time of the target action detected by the detection unit 12 and the part ID. The output unit 14 of the element operation division device 10 according to the first variation example generates and outputs the part unit element operation data 19d based on the element operation information 19c and the target action information 19b.

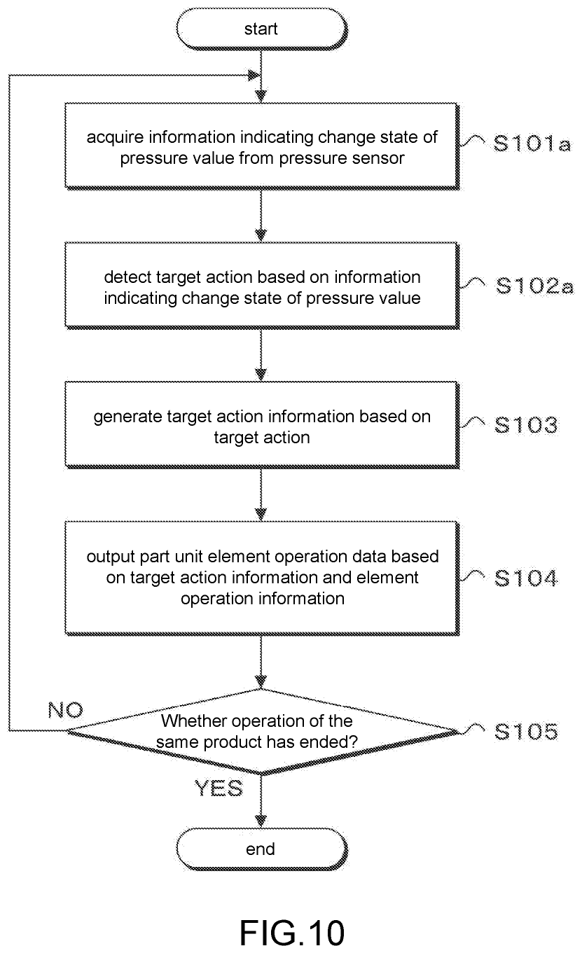

An element operation division process executed by the element operation division device 10 according to the first variation example is described with reference to FIG. 10. Among the element operation division process, step S103 and subsequent steps have the same process content as that of step S103 and subsequent steps of the element operation division process executed by the element operation division device 10 according to the above-described embodiment, and thus description of the processes in step S103 and subsequent steps is omitted. In the following, the processes in step S101a and step S102a different from those of the above-described embodiment are described.

First, the acquisition unit 11 of the element operation division device 10 acquires information indicating the change state of the pressure value from the pressure sensor 30 (step S101a).

Subsequently, the detection unit 12 of the element operation division device 10 detects the target action based on the information indicating the change state of the pressure value acquired in step S101a (step S102a). Specifically, the detection unit 12 detects the target action based on the position on the operation table corresponding to a pressure sensor 30 in which the pressure value has changed among the plurality of pressure sensors 30 arranged on the operation table and the change state of the pressure value.

In this way, according to the element operation division device 10 of the first variation example, the information indicating the change state of the pressure value relating to the action of the operator A can be acquired, the target action which is determined in advance in order that the target action is judged to correspond to the action of contacting or separating the parts can be detected from the information indicating the change state of the pressure value, the target action information 19b in which the detected target action is associated with the occurrence time thereof and the part ID can be generated, and the part unit element operation data 19d for dividing the information indicating the change state of the pressure value in part units and element operation units can be output based on the target action information 19b and the element operation information 19c in which a start action and an end action of each element operation are determined.

### Second Variation Example

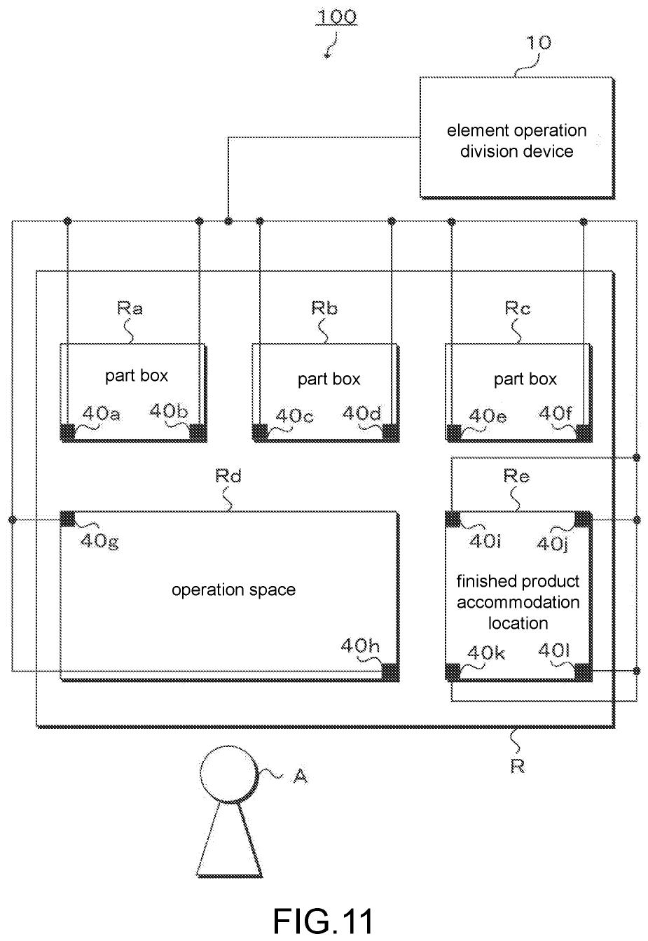

An element operation division system 100 according to a second variation example is described with reference to FIG. 11. The element operation division system 100 according to the second variation example estimates the state of an event (output signal) that changes depending on the action (operation) of the operator A performed in one operation region (operation table) R with photoelectric sensors 40a, 40b, 40c, 40d, 40e, 40f, 40g, 40h, 40i, 40j, 40k, and 401 (hereinafter also referred to as “photoelectric sensors 40”), and information indicating a change in the estimated event is transmitted to the element operation division device 10 as the time-series information.

Here, the event estimated by the photoelectric sensor 40 may be set as, for example, the hand of the operator A entering the target region (IN state) or that the hand of the operator A leaving the target region (OUT state). The target region at this time becomes, for example, a region formed by each of the part boxes Ra, Rb, and Rc, the operation space Rd, and the finished product accommodation location Re.

The photoelectric sensor 40 is preferably arranged at a position where estimation can be made on whether each target region is in the IN state or the OUT state. In addition, it is preferable that a correspondence relationship of each photoelectric sensor 40 with each of the part boxes Ra, Rb, and Rc, the operation space Rd, and the finished product accommodation location Re is stored in the storage unit 19. Thereby, when the change in the event is estimated by any one of the photoelectric sensors 40, the position on the operation table associated with this photoelectric sensor 40 can be specified.

The detection unit 12 of the element operation division device 10 according to the second variation example detects the target action based on the information indicating the change in the event acquired by the acquisition unit 11. The target action can be determined in advance in order that the target action is judged to correspond to the action of contacting or separating the parts. For example, the target action is determined in advance in order that the target action is judged to correspond to each action of a hand contacting a part, a part being separated from a part, a part contacting a part, a finished product contacting an accommodation location, a hand being separated from a finished product, and the like. Specifically, when the event estimated by the photoelectric sensor 40a and the photoelectric sensor 40b is changed to the IN state, it can be judged that the hand contacts the part Pa, and when the event estimated by the photoelectric sensor 40a and the photoelectric sensor 40b is changed to the OUT state, it can be judged that the part Pa is separated from the group of parts Pa.

The generation unit 13 of the element operation division device 10 according to the second variation example generates the target action information 19b including the occurrence time of the target action detected by the detection unit 12 and the part ID. The output unit 14 of the element operation division device 10 according to the second variation example generates and outputs the part unit element operation data 19d based on the element operation information 19c and the target action information 19b.

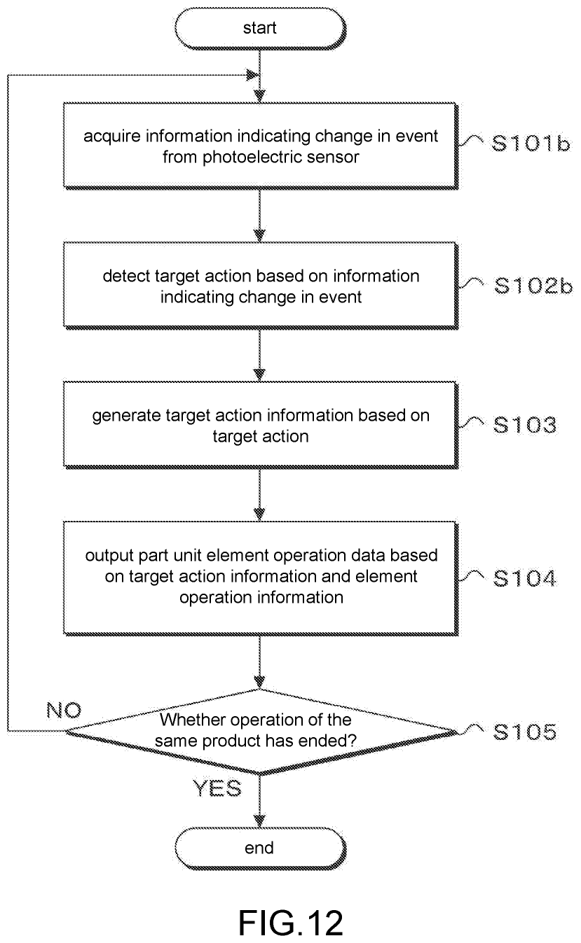

An element operation division process executed by the element operation division device 10 according to the second variation example is described with reference to FIG. 12. In the element operation division process, step S103 and subsequent steps have the same process content as that of step S103 and subsequent steps of the element operation division process executed by the element operation division device 10 according to the above-described embodiment, and thus description of the processes in step S103 and subsequent steps is omitted. In the following, the processes in step S101b and step S102b different from those of the above-described embodiment are described.

First, the acquisition unit 11 of the element operation division device 10 acquires information indicating the change in the event from the photoelectric sensor 40 (step S101b).

Subsequently, the detection unit 12 of the element operation division device 10 detects the target action based on the information indicating the change in the event acquired in step S101b (step S102b). Specifically, the detection unit 12 detects the target action based on the position on the operation table corresponding to a photoelectric sensor 40 in which the event has changed among the plurality of photoelectric sensors 40 arranged on the operation table.

In this way, according to the element operation division device 10 of the second variation example, the information indicating the change in the event relating to the action of the operator A can be acquired, the target action which is determined in advance in order that the target action is judged to correspond to the action of contacting or separating the parts can be detected from the information indicating the change in the event, the target action information 19b in which the detected target action is associated with the occurrence time thereof and the part ID can be generated, and the part unit element operation data 19d for dividing the information indicating the change in the event in part units and element operation units can be output based on the target action information 19b and the element operation information 19c in which a start action and an end action of each element operation are determined.

Moreover, in the above-described embodiment and each variation example, each operation of gripping, transportation, adjustment, and accommodation is used as the element operation to illustratively give description, but the element operation is not limited hereto. The operation corresponding to the element operation can be appropriately determined based on the content of the operation performed by the operator. For example, the operation of “visually recognizing” the parts accommodated in the part boxes Ra, Rb, and Re may be included in the element operation.

Information indicating the movement of the line-of-sight of the operator A detected by a line-of-sight detection sensor can be used as the time-series information when whether to correspond to the operation of “visual recognition” is judged. As the line-of-sight detection sensor, it is preferable to use, for example, a spectacle-type wearable line-of-sight detection sensor.

In addition, the embodiment of the disclosure can also be described as the following appendixes. However, the embodiment of the disclosure is not limited to the forms described in the following appendixes. In addition, the embodiment of the disclosure may have a form in which the descriptions among the appendixes are replaced or combined.

### Appendix 1

An element operation division device, including:

an acquisition unit (11) that acquires time-series information relating to an action of an operator;

a detection unit (12) that detects, from the time-series information, a target action which is determined in advance in order that the target action is judged to correspond to an action of contacting or separating parts;

a generation unit (13) that associates action information indicating the detected target action with an occurrence time of the target action and identification information of the parts to generate target action information;

a storage unit (19) that stores element operation information generated by associating start action information and end action information with respective element operations, wherein the start action information indicates an action of starting each of a plurality of the element operations in a series of operations, and the end action information indicates an action of ending each of the element operations; and an output unit (14) that outputs, based on the target action information and the element operation information, data in which a start time and an end time of each of the element operations are associated with this element operation for each piece of identification information of the parts.

### Appendix 2

The element operation division device according to appendix 1,

wherein the time-series information is time-series information output by at least one of an image sensor (20), a pressure sensor (30), a photoelectric sensor (40), and a line-of-sight detection sensor.

### Appendix 3

The element operation division device (10) according to appendix 2, wherein

when the time-series information is output by the image sensor (20),

the detection unit (12) detects the target action based on a position on an image at which a hand of the operator is present.

### Appendix 4

The element operation division device (10) according to appendix 2, wherein

when the time-series information is detected by the pressure sensor (30), the detection unit (12) detects the target action based on a position on an operation table corresponding to a pressure sensor (30) in which a pressure value has changed among a plurality of pressure sensors (30) arranged on the operation table and a change state of the pressure value.

### Appendix 5

The element operation division device (10) according to appendix 2, wherein

when the time-series information is detected by the photoelectric sensor (40), the detection unit (12) detects the target action based on a position on an operation table corresponding to a photoelectric sensor (40) in which an output signal has changed among a plurality of photoelectric sensors (40) arranged on the operation table.

### Appendix 6

An element operation division method, including:

acquiring time-series information relating to an action of an operator; detecting, from the time-series information, a target action which is determined in advance in order that the target action is judged to correspond to an action of contacting or separating parts;

associating action information indicating the detected target action with an occurrence time of the target action and identification information of the parts to generate target action information;

storing element operation information generated by associating start action information and end action information with respective element operations, wherein the start action information indicates an action of starting each of a plurality of the element operations in a series of operations, and the end action information indicates an action of ending each of the element operations; and

outputting, based on the target action information and the element operation information, data in which a start time and an end time of each of the element operations are associated with this element operation for each piece of identification information of the parts.

### Appendix 7

A non-transitory computer readable storage medium, storing an element operation division program,

causing a computer to function as:

an acquisition unit (11) that acquires time-series information relating to an action of an operator;

a detection unit (12) that detects, from the time-series information, a target action which is determined in advance in order that the target action is judged to correspond to an action of contacting or separating parts;

a generation unit (13) that associates action information indicating the detected target action with an occurrence time of the target action and identification information of the parts to generate target action information;

a storage unit (19) that stores element operation information generated by associating start action information and end action information with respective element operations, wherein the start action information indicates an action of starting each of a plurality of the element operations in a series of operations, and the end action information indicates an action of ending each of the element operations; and

an output unit (14) that outputs, based on the target action information and the element operation information, data in which a start time and an end time of each of the element operations are associated with this element operation for each piece of identification information of the parts.

### Appendix 8

An element operation division system (100), including one or more sensors and an element operation division device (10), wherein

the sensor includes

an estimation unit that estimates an action of an operator and outputs time-series information relating to the action, and

the element operation division device (10) includes:

an acquisition unit (11) that acquires the time-series information;

a detection unit (12) that detects, from the time-series information, a target action which is determined in advance in order that the target action is judged to correspond to an action of contacting or separating parts;

a generation unit (13) that associates action information indicating the detected target action with an occurrence time of the target action and identification information of the parts to generate target action information;

a storage unit (19) that stores element operation information generated by associating start action information and end action information with respective element operations, wherein the start action information indicates an action of starting each of a plurality of the element operations in a series of operations, and the end action information indicates an action of ending each of the element operations; and

an output unit (14) that outputs, based on the target action information and the element operation information, data in which a start time and an end time of each of the element operations are associated with this element operation for each piece of identification information of the parts.

What is claimed is:

1. An element operation division device, comprising:
an acquisition unit that acquires time-series information relating to an action of an operator;
a detection unit that detects, from the time-series information, a target action which is determined in advance in order that the target action is judged to correspond to an action of contacting or separating parts;
a generation unit that associates action information indicating the detected target action with an occurrence time of the target action and identification information of the parts to generate target action information;
a storage unit that stores element operation information generated by associating start action information and end action information with respective element operations, wherein the start action information indicates an action of starting each of a plurality of the element operations in a series of operations, and the end action information indicates an action of ending each of the element operations; and
an output unit that outputs, based on the target action information and the element operation information, data in which a start time and an end time of each of the element operations are associated with this element operation for each piece of identification information of the parts.

2. The element operation division device according to claim 1,
wherein the time-series information is time-series information output by at least one of an image sensor, a pressure sensor, a photoelectric sensor, and a line-of-sight detection sensor.

3. The element operation division device according to claim 2, wherein
when the time-series information is output by the image sensor,
the detection unit detects the target action based on a position on an image at which a hand of the operator is present.

4. The element operation division device according to claim 2, wherein
when the time-series information is detected by the pressure sensor,
the detection unit detects the target action based on a position on an operation table corresponding to a pressure sensor in which a pressure value has changed among a plurality of pressure sensors arranged on the operation table and a change state of the pressure value.

5. The element operation division device according to claim 2, wherein
when the time-series information is detected by the photoelectric sensor,
the detection unit detects the target action based on a position on an operation table corresponding to a photoelectric sensor in which an output signal has changed among a plurality of photoelectric sensors arranged on the operation table.

6. An element operation division method, comprising:
acquiring time-series information relating to an action of an operator;
detecting, from the time-series information, a target action which is determined in advance in order that the target action is judged to correspond to an action of contacting or separating parts;
associating action information indicating the detected target action with an occurrence time of the target action and identification information of the parts to generate target action information;
storing element operation information generated by associating start action information and end action information with respective element operations, wherein the start action information indicates an action of starting each of a plurality of the element operations in a series of operations, and the end action information indicates an action of ending each of the element operations; and
outputting, based on the target action information and the element operation information, data in which a start time and an end time of each of the element operations are associated with this element operation for each piece of identification information of the parts.

7. A non-transitory computer readable storage medium, storing an element operation division program,
causing a computer to function as:
an acquisition unit that acquires time-series information relating to an action of an operator;
a detection unit that detects, from the time-series information, a target action which is determined in advance in order that the target action is judged to correspond to an action of contacting or separating parts;
a generation unit that associates action information indicating the detected target action with an occurrence time of the target action and identification information of the parts to generate target action information;
a storage unit that stores element operation information generated by associating start action information and end action information with respective element operations, wherein the start action information indicates an action of starting each of a plurality of the element operations in a series of operations, and the end action information indicates an action of ending each of the element operations; and
an output unit that outputs, based on the target action information and the element operation information, data in which a start time and an end time of each of the element operations are associated with this element operation for each piece of identification information of the parts.

8. An element operation division system, comprising one or more sensors and an element operation division device, wherein
the sensor comprises:
an estimation unit that estimates an action of an operator and outputs time-series information relating to the action, and
the element operation division device comprises:
an acquisition unit that acquires the time-series information;
a detection unit that detects, from the time-series information, a target action which is determined in advance in order that the target action is judged to correspond to an action of contacting or separating parts;
a generation unit that associates action information indicating the detected target action with an occurrence time of the target action and identification information of the parts to generate target action information;
a storage unit that stores element operation information generated by associating start action information and end action information with respective element operations, wherein the start action information indicates an action of starting each of a plurality of the element operations in a series of operations, and the end action information indicates an action of ending each of the element operations; and
an output unit that outputs, based on the target action information and the element operation information, data in which a start time and an end time of each of the element operations are associated with this element operation for each piece of identification information of the parts.
